(19) United States
(12) Patent Application Publication
(10) Pub. No.: US 2020/0239379 A1
(43) Pub. Date: Jul. 30, 2020

(54) Method and Apparatus for Automated Composting of Organic Wastes

(71) Applicant: Aveterra Corp, Bainbridge Island, WA (US)

(72) Inventor: Timothy McAdoo, Bainbridge Island, WA (US)

(21) Appl. No.: 16/756,833

(22) PCT Filed: Nov. 16, 2018
(86) PCT No.: PCT/US2018/061685

§ 371 Date: Apr. 16, 2020

Related U.S. Application Data
(60) Provisional application No. 62/581,761, filed on Nov. 5, 2017.

(51) Int. Cl. C05F 17/70; C05F 17/921; C05F 17/986

(52) U.S. Cl. CPC C05F 17/70; C05F 17/986; C05F 17/939

(57) ABSTRACT

An automated compost management system for commercial agribusiness provides a compost station having multiple parallel compost bays, with automated mixing and moisture control of the compost by an automated gantry assembly, and automated compost aeration and leachate management.

### CROSS-REFERENCE TO RELATED APPLICATIONS

This is a National Stage, non-provisional patent application to the United States claiming priority to International Application PCT/US2018/061685 filed Nov. 16, 2018, and claiming priority to U.S. Provisional Application No. 62/581,761, filed Nov. 5, 2017.

### TECHNICAL FIELD

The present disclosure relates to automated composting of organic wastes, and more particularly, to automated mixing of compost piles especially for handling farm, ranch, or agribusiness animal wastes.

### BRIEF DESCRIPTION OF THE DRAWING

For a more complete understanding of the features and advantages of the present disclosure, reference is now made to the detailed description of the disclosure along with the accompanying figures in which corresponding numerals in the different figures refer to corresponding parts and in which:

FIG. 1 is an orthogonal view of an exemplary compost station having multiple composting bays according to an aspect of the invention.

FIG. 2 is an overhead view of the compost station of FIG. 1, according to an aspect of the disclosure.

FIG. 3 is a side view of the exemplary compost station of FIG. 1 according to an embodiment of the disclosure.

FIG. 4 is a detail view of a rail assembly for use with the gantry assembly according to an aspect of the disclosure.

FIG. 5 is an orthogonal view of an exemplary auger and gantry assembly according to an aspect of the disclosure.

FIG. 6 is a top view of the auger and gantry assembly of FIG. 5 according to an aspect of the disclosure.

FIG. 7 is a side view of the auger and gantry assembly of FIG. 5 according to an aspect of the disclosure.

FIG. 8 is a detail view of an exemplary auger assembly according to an aspect of the disclosure.

FIG. 9 is a detail view of an exemplary carrier rail and wheel according to an aspect of the disclosure.

FIG. 10 is a detail orthogonal view of an exemplary compost station having an exemplary leachate management assembly according to an aspect of the disclosure.

FIG. 11 is a schematic view of an exemplary leachate management assembly according to an aspect of the disclosure.

FIG. 12 is a top view of an exemplary leachate management assembly according to an aspect of the disclosure.

FIG. 13 is a side view of the exemplary leachate management assembly of FIG. 12 according to an aspect of the disclosure.

FIG. 14 is a detail end view of the exemplary leachate management assembly of FIG. 12 according to an aspect of the disclosure.

FIG. 15 is a detail top view of the exemplary leachate management assembly of FIG. 12 according to an aspect of the disclosure.

FIG. 16 is a top view of an exemplary compost station having an exemplary pivot gantry assembly according to an aspect of the disclosure.

FIG. 17 is an end partial view of an exemplary compost bay wall with an exemplary integrated track assembly according to an aspect of the disclosure.

FIG. 18 is an end partial view of an exemplary compost bay wall with an exemplary integrated track assembly according to an aspect of the disclosure.

FIG. 19 is a schematic showing a computerized network according to aspects of the disclosure for controlling the various assemblies and systems of the compost management system.

FIG. 20 is an exemplary flow chart for implementation by a computer software program for controlling the operable assemblies of the disclosure.

### DETAILED DESCRIPTION

An automated composting station is envisioned providing some or all of the following: automated augering, mixing, or agitation of compost piles positioned in longitudinal concrete bays; automated leachate collection and use of captured leachate to add moisture content to the compost piles; automated aeration of the compost piles; automated moisture control of the compost piles including addition of moisture as necessary; and sensor systems for detecting compost temperature, moisture content, and oxygenation.

The automated functions are provided for adjacent compost bays while allowing for clearing of the bays using a front loader device.

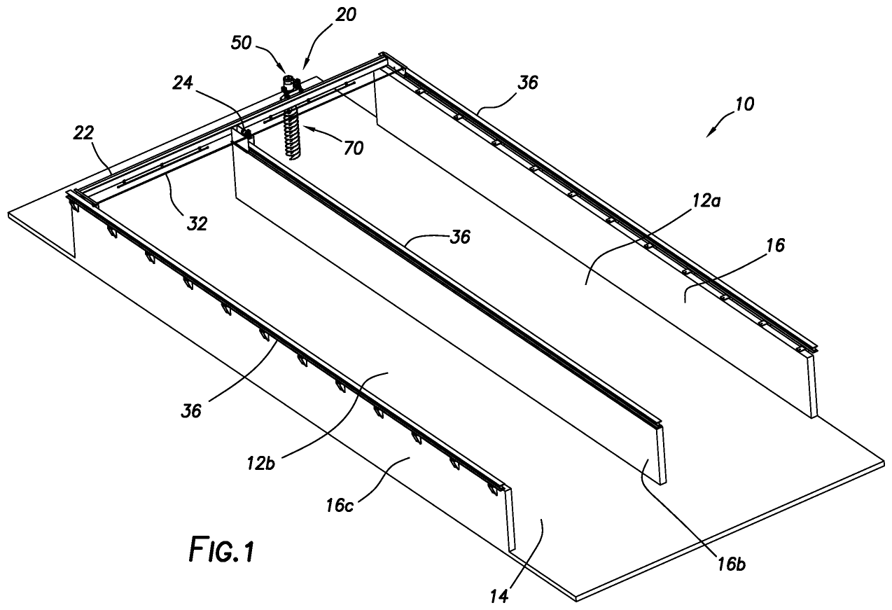

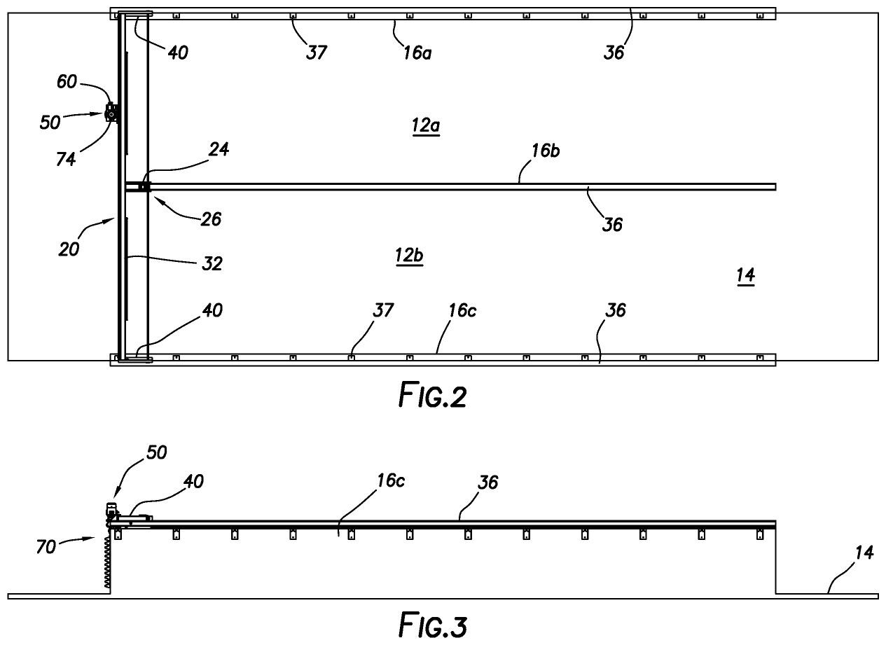

FIG. 1 is an orthogonal view of an exemplary compost station having multiple composting bays according to an aspect of the invention. FIG. 2 is an overhead view of the compost station of FIG. 1, according to an aspect of the disclosure. FIG. 3 is a side view of the exemplary compost station of FIG. 1 according to an embodiment of the disclosure. The Figures are discussed together.

A typical compost station 10 includes multiple, parallel, longitudinal compost bays 12, such as bays 12a and 12b, having a concrete floor 14 and concrete (or similar) walls 16, such as exterior walls 16a and 16c and intermediate wall 16b, defining each bay 12. Typically the bays 12 are open at both ends. The exterior station walls 16a and 16c are preferably slightly longer than the one or more intermediate bay walls 16b, allowing for movement of the auger between adjacent bays 12, that is, from one bay to another bay.

A typical compost bay 12 can be between 10 to 16 feet wide, although other sizes can be used. A typical bay can be between 100-120 feet long, although again other sizes can be used. Typical bay walls 12 can be between 5 and 6 feet tall, although other heights can be used. Compost piles located within the bays can be as high as the walls 12, although they are preferably somewhat shorter than the walls 12 to allow for unimpeded movement of the gantry and auger device along the bays. A typical compost pile will obviously have a mounded profile, typically shallower towards the ends of the bay and deeper towards the center of the compost pile.

### Automated Gantry-Mounted Auger Assembly

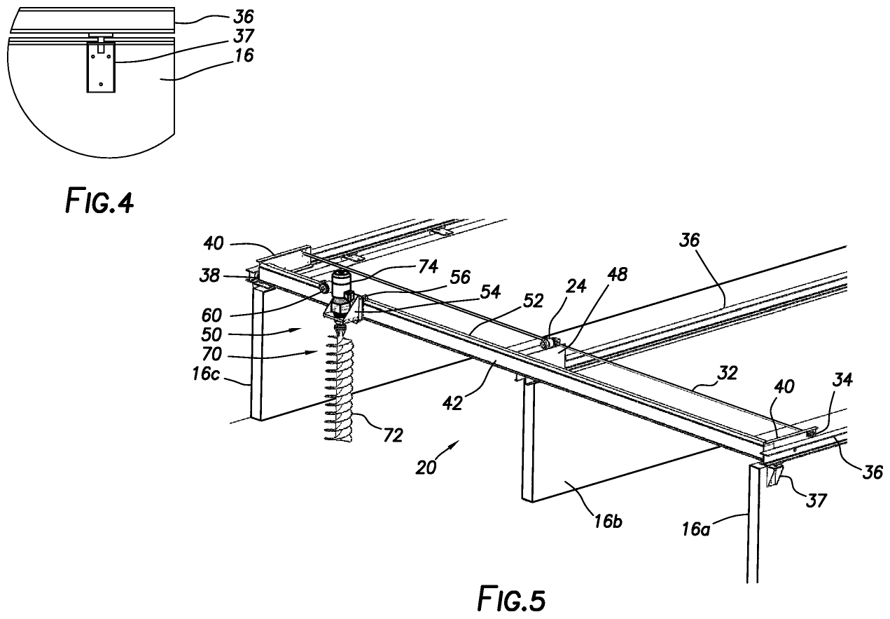

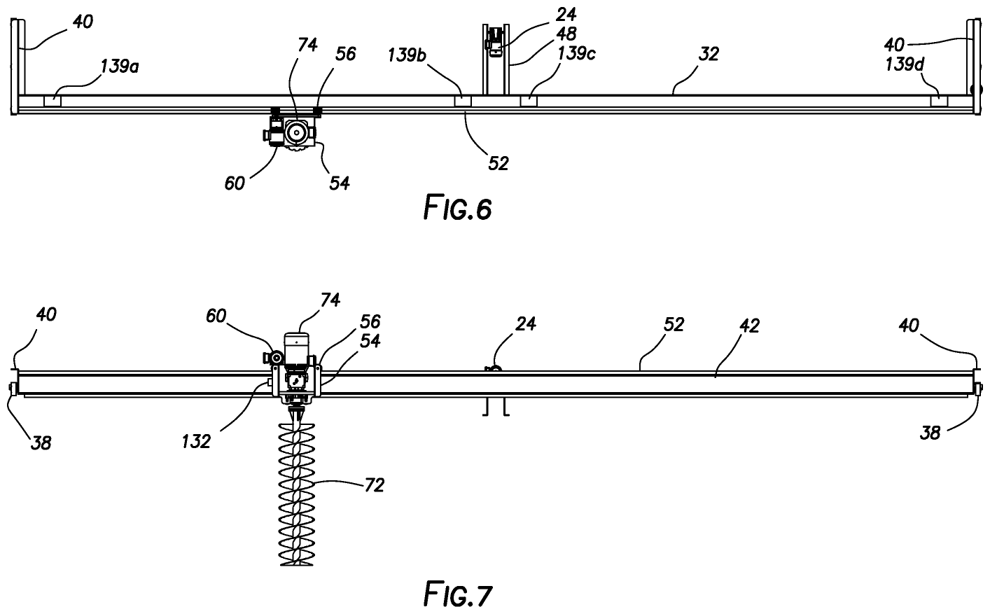

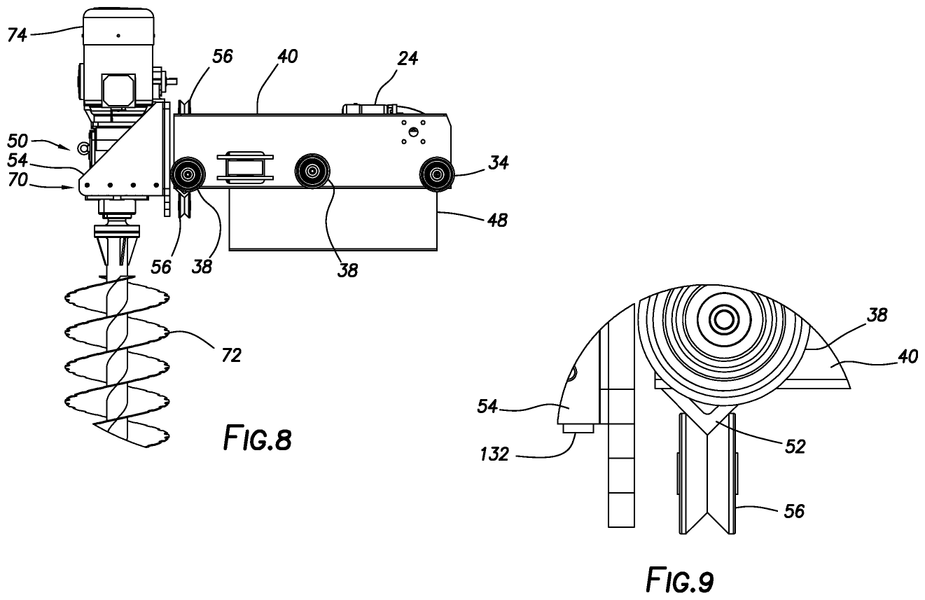

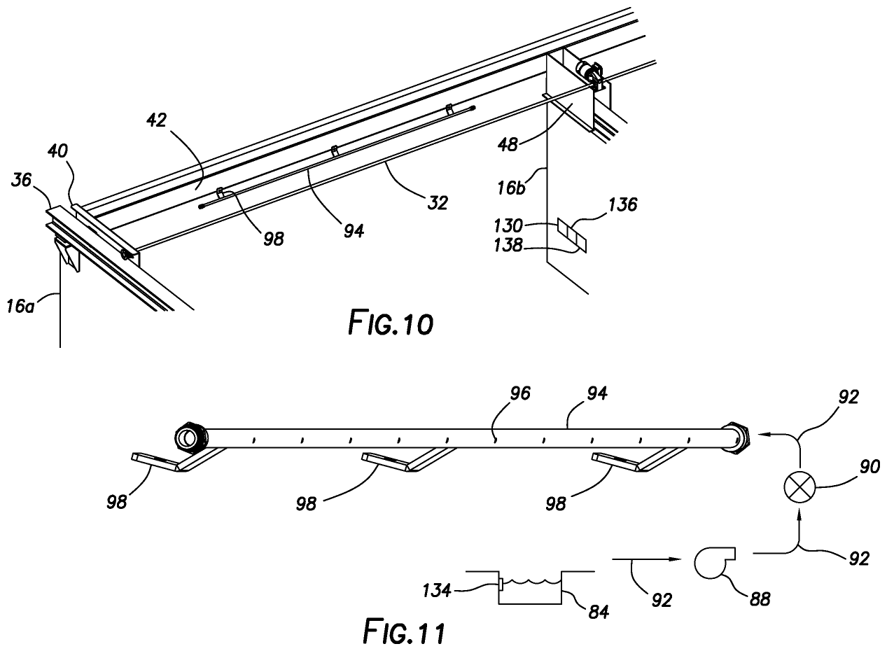

FIG. 4 is a detail view of a rail assembly for use with the gantry assembly according to an aspect of the disclosure. FIG. 5 is an orthogonal view of an exemplary auger and gantry assembly according to an aspect of the disclosure. FIG. 6 is a top view of the auger and gantry assembly of FIG. 5 according to an aspect of the disclosure. FIG. 7 is a side view of the auger and gantry assembly of FIG. 5 according to an aspect of the disclosure. FIG. 8 is a detail view of an exemplary auger assembly according to an aspect of the disclosure. FIG. 9 is a detail view of an exemplary carrier rail and wheel according to an aspect of the disclosure. The Figures are discussed together.

A powered gantry assembly 20 is positioned to operate in multiple adjacent compost bays 12. The powered gantry assembly 20 is positioned laterally across the bays 12. The gantry assembly 20 can extend across multiple bays, but for purposes of discussion, the gantry is shown extending across two adjacent bays 12a-b defined by three walls 16a-c, namely, opposing exterior walls 16a and 16c and a central intermediate wall 16b. Multiple dividing intermediate walls 16b can be employed to define multiple adjacent bays.

The powered gantry assembly 20 includes a gantry frame 22 extending across the adjacent compost bays 12. The gantry frame 22 allows for operable connection of gantry assembly components, such as gantry motor 24, drive system 26, laterally movable auger assembly 70, gantry rails 36, etc. Various gantry types and supports can be used, such as hanging gantries, wheeled gantries which roll upon the floor (whether inside or outside of the bay walls), rail mounted gantries, etc., as is known in the art.

The gantry motor 24 is seen mounted at the center of the system although the motor can be mounted elsewhere. The gantry motor 24 can be electric, internal combustion, or otherwise powered as is known in the art. The gantry motor 24 can be single or multiple speed, and/or reversible. In an embodiment, the gantry motor 24 is a high reduction, electric motor with approximately one horsepower. Obviously other types of motor, horsepower, and speeds can be used.

In an exemplary embodiment, the powered gantry and driven carriage assembly 50 are designed to mix compost in a compost bay 12 approximately 10 feet wide and 100 feet long in about an hour. An exemplary mixing pattern would consist of, once the auger was in contact with the compost, having the gantry assembly 20 move forward (e.g., about between 18 to 24 inches) between consecutive lateral sweeps of the compost bay by the carriage-mounted auger.

A drive system 26 includes the gantry motor 24 operably connected to drive a drive train 32. The drive train 32 extends from the gantry motor 24 to one or more drive wheels 34. The drive train 32 extends across multiple adjacent bays 12 as necessary to power the drive wheels 34. The drive train 32 can be one or more drive shafts, a chain or belt drive system, etc., as is known in the art. The drive train 32 is powered and selectively driven by the gantry motor 24. The direction of travel of the gantry assembly is reversible whether through reversing the direction of the motor, a transmission for the drive train, or otherwise as is known in the art.

Gantry drive wheels 34 are positioned at the bay walls 16 and can run along the tops of the exterior walls 16a and 16c, for example. For example, gantry rails 36 can be mounted on the top of the exterior walls 16a and 16c to support and guide the gantry wheels. Gantry rails 36 are seen in FIG. 4 mounted atop wall 16 be mounting brackets 37.

The gantry wheels include drive or powered wheels 34 and can also include dummy or non-powered wheels 38. In an embodiment, the gantry wheels are made of urethane.

The gantry frame 22 can include in some embodiments opposed end trucks 40 and one or more girders 42. The gantry assembly can include the frame 22 and frame parts, a drive motor platform 44, drive motor 24, drive wheels 34, dummy wheels 38, drive train 32, a trolley or carriage assembly 50, etc. In the embodiment shown, the end trucks 40 are attached to and support the girder or girders 42, allow attachment of the drive and dummy wheels 34 and 38, support the ends of the drive train 32, and support the ends of the carriage rails 52. The motor platform 48 can be supported by and attached to a girder 42, for example.

The powered gantry assembly 20 includes a driven carriage assembly 50 mounted for driven, reciprocating, lateral movement along the gantry frame, laterally across the bays. The driven carriage assembly 50 translates across the gantry frame and the bay on one or more carriage rails 52, which can be rods, channels, tubulars, V-shaped rods, or other structures of the gantry assembly. The driven carriage can be moved reciprocally, that is, back and forth across the bay. In an embodiment, the carriage assembly 50 includes a carriage frame 54, multiple carriage wheels 56 attached to the frame, and a carriage motor 60 for driving the carriage assembly. In an exemplary embodiment, upper and lower carriage wheels or load runners 56 cooperate with upper and lower carriage rails 52, which support the carriage, maintain the carriage in a vertical position, and along which the carriage moves.

The carriage motor 60 for driving the carriage can be single or variable speed, reversible, electric or otherwise powered. An exemplary carriage motor in an embodiment is approximately one horsepower. The carriage is movable along the rails in either direction as the direction of travel is reversible, whether through reversing the direction of the carriage motor, a transmission for the drive train, or otherwise as is known in the art.

The carriage supports a powered mixing assembly or auger assembly 70. The auger assembly 70 includes a rotary auger blade 72 (or mixing blade of any type) extending downwardly from the carriage and into the bay below. The auger blade 72 is powered by an auger motor 74, preferably also mounted on the carriage. The auger motor 74 can be single or variable speed, reversible, electric or otherwise powered. The auger motor 74, in an exemplary embodiment, is approximately 10-15 horsepower. As used herein, auger assembly, auger, auger blade, and the like mean and include mixing assemblies, mixers, and mixing blades, whether the blades are helical, spiral, flat, or other shapes, as are known in the art.

In use, the gantry 20 moves longitudinally along a selected bay 12, taking with it the carriage assembly 50 and auger assembly 70. The auger assembly 70, mounted to the carriage assembly 50, moves laterally back and forth across the bay 12 between the walls 16 defining the bay 12. The combined movement of the gantry and carriage can position the auger blade 72 basically anywhere in a bay. The auger blade 72 can be moved in a pattern, for example a zig-zag or serpentine pattern, through the bay.

The gantry makes it possible to move the auger assembly from one bay to another. For example, when the gantry 20 reaches the open end of the bay 12a, the carriage assembly 50 moves laterally along the gantry 20 from the first bay 12a to the second bay 12b, thereby positioning the auger blade 72 to churn the compost of the second bay 12b. As explained above, the gantry can span multiple bays allowing a single auger to operate sequentially across the bays. Although two bays are shown, multiple bays can be used, with the auger accessing selected bays by lateral movement across the gantry spanning the bays. In an embodiment, the intermediate wall 16b or walls between bays are shorter than the exterior bay walls 16a and 16c. The longitudinal difference in length creates a “gap” or space for the auger assembly 70 and blade 72 to traverse between bays 12 without contacting the intervening intermediate wall 16b. More complicated arrangements are possible. For example, the auger assembly 70 can be pivotally mounted to swing the auger blade 72 to a horizontal position such that it clears the top of the intermediate wall 16b as the carriage assembly 50 moves to an adjacent bay.

FIG. 16 is an alternate embodiment of a gantry assembly including a pivoting gantry assembly 220. The pivoting assembly 220 moves along compost bays 12 longitudinally in a manner similar to that described above. A first end 221 of the gantry assembly runs along an exterior bay wall 16a while the second end 223 of the gantry assembly runs along an intermediate wall 16b of the bays 12. In an embodiment, the drive wheels 234 of the gantry assembly run along the intermediate wall 16b while idler wheels 238 are supported at the exterior wall 16a. Once the gantry reaches the end of a bay 12, the gantry pivots about a pivot axis 235 defined at or adjacent the intermediate wall 16b, with the now free, first end 221 of the gantry disengaging from the exterior wall 16a of a first bay 12a and swinging to the exterior wall 16c of a second, adjacent bay 12b. The gantry assembly can be pivoted manually or automatically. The drive mechanism can be a timing belt, rack gear, or powered wheels on the center, dividing wall. The outer two exterior walls provide support for idler wheels.

In alternate embodiments, the gantry assembly 20 can move along the top of the walls 16 without the use of a rail 36 system. Instead, an integrated track can be used. For example, FIG. 17 is an end view of a bay wall 16 having an integrated track 236 consisting of a shaped wall portion 237. Here, the shaped wall portion 237 is a T-shaped section at the top of the wall. The shaped portion provides for moving attachment of the gantry assembly 20 to the wall 16. In the embodiment shown, the gantry truck 40 includes mounted guide wheels 238 which travel along guide tracks 240 defined on the undersides of the T-shaped section 237 and which provide rotational stability to the truck 40 and maintain the truck 40 atop the wall. One or more drive (or dummy) wheels 234 roll along the upper surface of the T-shaped section 237.

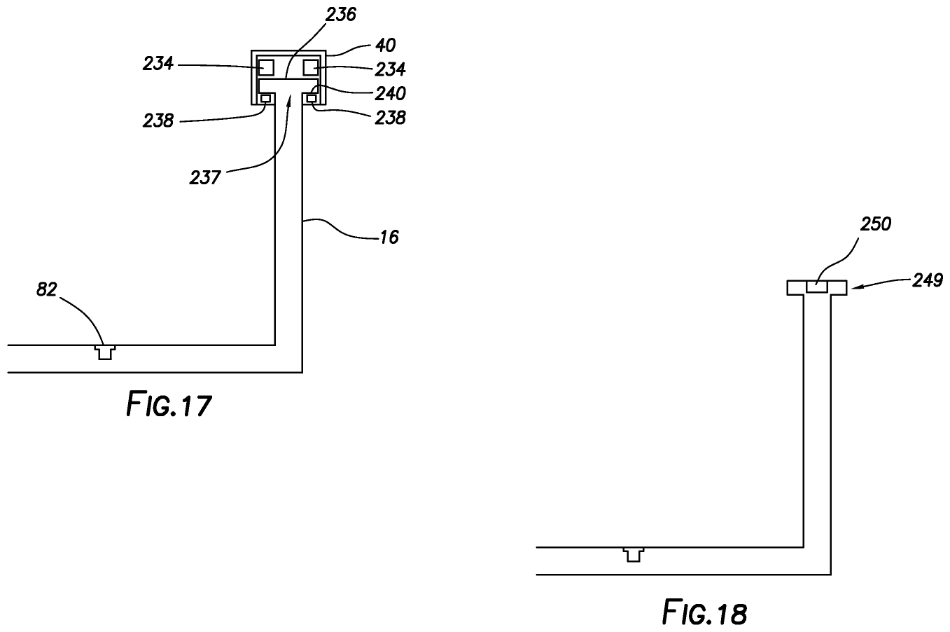

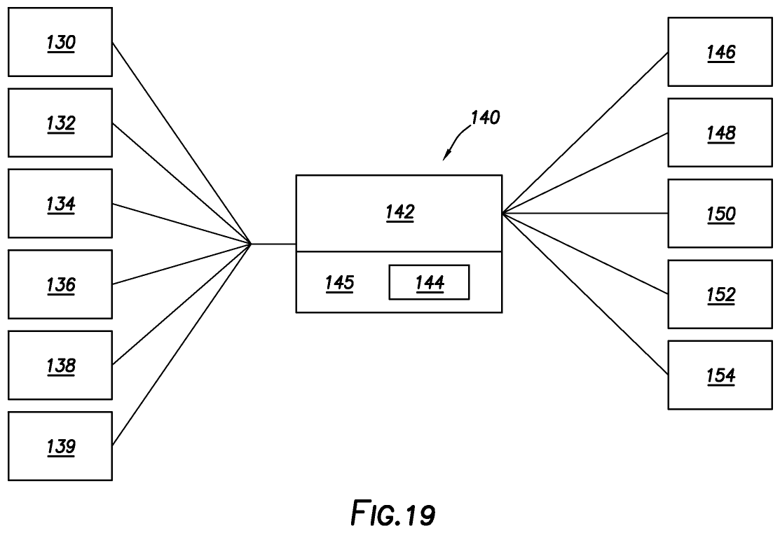

Also seen in FIG. 18 is an alternate embodiment of an integrated track 249 consisting of a shaped groove 250 running along the top of the wall 16. In this embodiment, the drive and dummy wheels at opposite ends of the gantry sit in and rung along the groove 250. The groove 250 constrains movement of the gantry wheels laterally, maintaining the gantry wheels atop the walls. The integrated track systems reduces costs associated with rail materials and installation.

### Leachate Management and Moisture Control Assemblies

As liquid seeps from organic compost or waste piles, it carries with it dissolved or entrained environmentally harmful substances that may then enter the environment. Consequently, leachate management is often prescribed by environmental regulations. The disclosure includes in some embodiments a leachate management system.

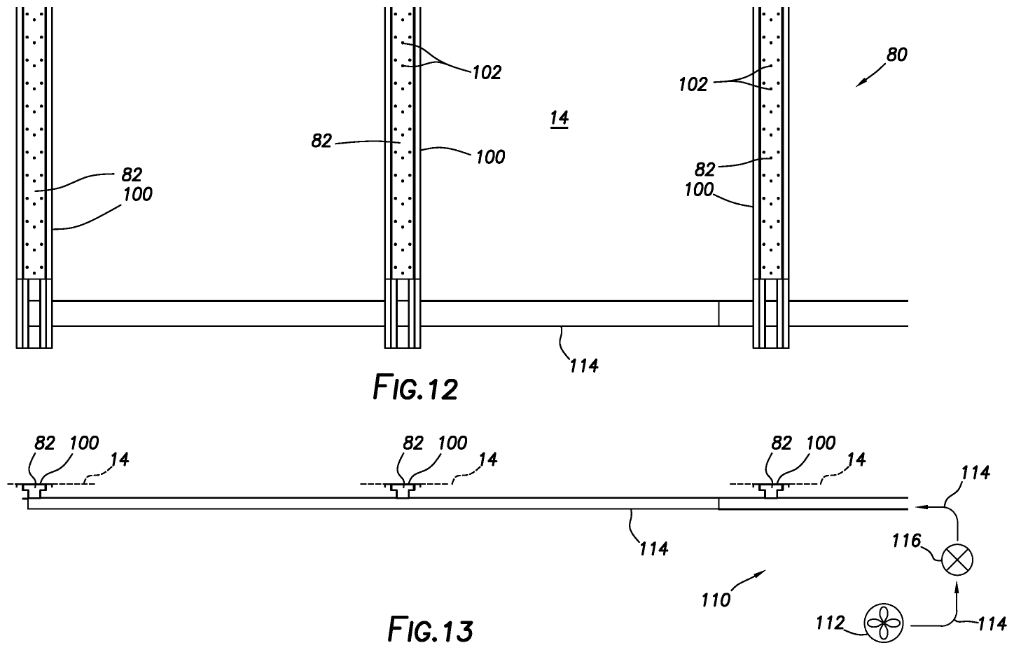

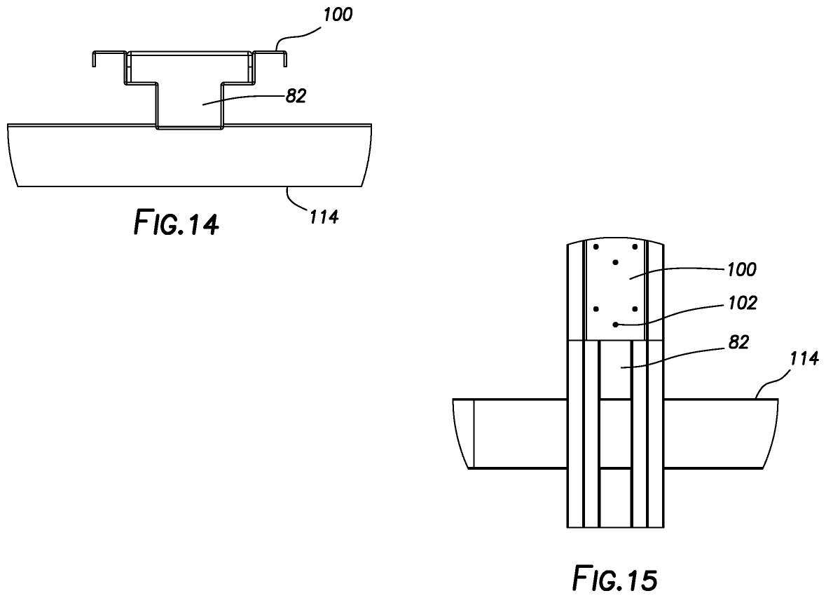

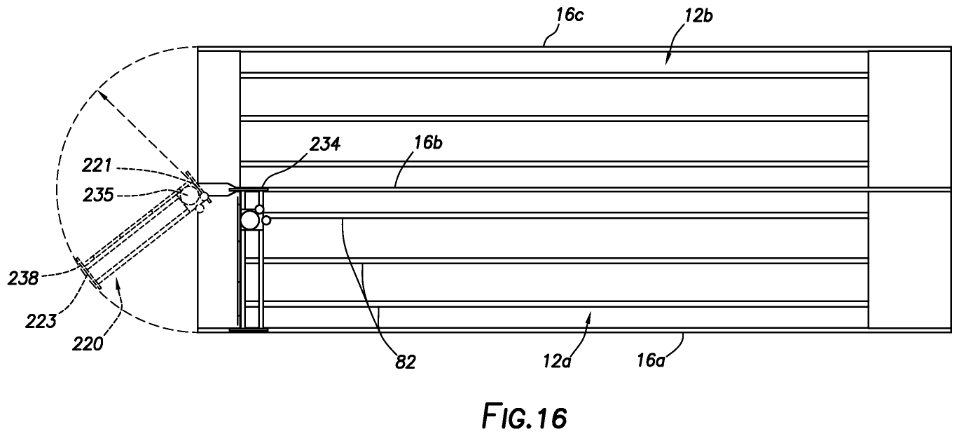

FIGS. 10-15 are views of an exemplary compost station having an exemplary leachate management assembly and exemplary aeration assembly according to an aspect of the disclosure and will be discussed together.

The leachate management system 80 includes one or more drainage channels 82 defined in the floor 14 of each compost bay 12. The drainage channels 82 can be defined by the concrete floor 14 and can be lined, such as with metal channels positioned in the concrete. The channels 82 and/or floor 14 are sloped to force collection of leachate fluid at a leachate well or pool 84, preferably located at one end of the bay 12. For example, the channels 82 can slope at approximately a 4:1 slope. As an example, a leachate channel 82 can measure 6 inches wide and 1 inch deep at a first, “uphill” end, and 6 inches wide and 4 inches deep at a second, “downhill” end over the length of an approximately 100 feet long compost bay.

The leachate well 84 can include a leachate sensor assembly 134 having one or more fluid level sensors for detecting the leachate fluid level of the well. Additionally, the leachate sensor assembly 134 can detect physical and chemical parameters of the leachate, such as temperature, pH, content of specific chemicals, oxygen, etc. When the well is full or when it is determined that the compost lacks moisture content, a leachate pump 88 can pump the fluid via control of appropriate valves 90 and hoses and piping 92 back into the compost piles in the bays 12. Water or other liquid sources can be added to the leachate for pumping onto the compost as desired.

The leachate control assembly 80 can include liquid dispersal mechanisms 94, such as perforated tubes, having dispersion apertures 96, mounted to the gantry assembly 20 by mounts 98, for dispersing liquids, including gathered leachate, onto the compost piles in the bays. The dispersal mechanisms are in fluid communication with a liquids source, such as the leachate well or a water source. Fluid communication can be by an assembly of pipes, hoses, control valves and the like as is known in the art.

The pump 88 can be automatically activated, for example upon the sensor assembly 134 detecting that the leachate well is full, or upon detecting that the compost moisture has fallen below a selected level. Alternately, the pump can be activated manually. The gantry assembly 20 is run along the bays 12 while the liquid (e.g., water or leachate) is pumped through the valves 90 and piping 92 into the dispersion tubes 94, through the apertures 96, and onto the compost piles below.

It is desirable to move the compost into and out of the bays by use of a front-end loader mounted to a wheeled or tracked vehicle such as a tractor, skid steer, or the like. Such devices however are only safely usable where nothing obstructs the front end loader during use. Consequently, the leachate draining channels 82 are defined below the floor level. To prevent compost from simply filling the channels 82 and blocking flow, a number of grates 100 are installed over the channels 82 in some embodiments. The grates 100 themselves also are positioned flush with or below the floor level. In an embodiment, the grates 100 have a plurality of holes 102 approximately 3/16 inches in diameter. The channels 82 can be covered along some or most of their length, having entry points for leachate fluid at grates or other inlets along their length.

Aeration Assembly

Proper composting also requires proper aeration of the compost during decomposition to prevent the build-up of unwanted gases and to oxygenate the compost. In an embodiment, an aeration assembly 110 is provided having one or more fans 112 for moving air through a plurality of aeration conduits 114, valves 116, and the like.

In an embodiment, some of the aeration conduits 114 are positioned in the bay floors 14, below the surface of the floor. Air is effectively forced through the conduits 114, up through air holes 102 in the grates or covers 100 over the channels 82, and into the compost bay 12 below the compost pile. Alternately, the leachate system and aeration system can be separated, with aeration conduits 144 running along the channels 82 or in separate channels altogether.

Fans 112 force air through the holes 102 by creating sufficient static pressure to force air into the compost pile, regardless of whether some or all holes 102 are covered by compost. That is, the system provides sufficient static pressure to force air into the pile above the air conduits even though some of the holes will not be covered by compost. The number and size of the holes is such that less air flow is allowed through the holes than the fan can produce, thereby creating a static pressure in the aeration conduits. For example, a number of 3/16th inch holes are selected that together allow 300 standard cubic feet per minute (scfm) at 4 psi to flow through, while an aeration fan is selected having a capacity of twice to three times that scfm (e.g., 900 scfm).

Any type fan can be employed meeting these requirements. In some embodiments, fans can be squirrel cage type fans, centrifugal fans, or compressed air fans. Fans are preferably spark-resistant to reduce the chance of starting a fire in the compost.

### Sensor Assemblies

The automated system includes a number of sensor and measurement assemblies 130, the readings of which are automated. Additionally, in some embodiments, the sensor readings are then used to automatically trigger actions by other system components.

Sensors can be electrical, optical, piezoelectric, mechanical, etc. Measured parameters can include temperature, pressure, gas presence, concentration or ratios, moisture content or ratios, presence or absence of materials and fluids, level of materials and fluids, etc. It is understood that the terms “sensor,” “sensor assembly,” and the like refer not only to the actual sensor mechanism but also to the attached electronics for reading, translating, manipulating, and transmitting signals corresponding to sensor readings, as is known in the art. A sensor assembly 130 can include various and multiple individual sensors. A sensor assembly can measure the desired parameter directly or indirectly.

Moisture content of the compost should be monitored and maintained at selected levels. One or more moisture sensor assemblies 132 for measuring or determining moisture content of the compost pile can be permanently or removably mounted in the system, for example, at a compost bay wall or floor, on the gantry assembly, on the auger assembly, etc. For example, a moisture sensor assembly 132, such as an infrared sensor, can be mounted at the carriage subassembly 50 of the gantry assembly to measure (indirectly) moisture content of the compost below the carriage in the bay. The moisture sensor assembly can be part of a computerized system and can be operably connected to or in communication with one or more computers and software programs run by such computers.

A leachate sensor assembly 134 can be employed at the leachate well or other fluid reservoirs. The leachate sensor assembly can measure the leachate well fluid level or other parameters of the leachate fluid. The leachate sensor assembly can be part of a computerized system and can be operably connected to or in communication with one or more computers and software programs run by such computers.

Oxygenation of the compost pile can be measured, for example, by measuring oxygen content using an oxygen sensor assembly 136 permanently or removable mounted or positioned at a bay wall 16. Alternately, a sensor (e.g., infrared) can measure oxygen content and be mounted at the gantry assembly 20, etc. The sensor assemblies can include probes for contacting the compost, if desired. The probes can be retractable. Other gas sensor assemblies can be used, such as carbon dioxide, carbon monoxide, etc., as are known in the art. The oxygen sensor assembly can be part of a computerized system and can be operably connected to or in communication with one or more computers and software programs run by such computers.

Compost presence sensor assemblies 138 or the like can be employed to measure the presence, location, height or level of compost in a bay at any given location along the bay. Compost presence sensor assemblies can be positioned in or at the walls 16, on the gantry assembly 20, etc. In an embodiment, a compost presence sensor assembly includes one or more proximity sensors used to determine the presence of compost (at a selected height from the floor), such as an ultrasonic sensor or equivalent as is known in the art. The proximity sensor is mounted on the gantry assembly 20 or carriage assembly 50 and directed downward into the bay 12 towards the floor 14. Further, compost presence and levels can be sensed and measured by other sensor assemblies, such as torque sensors on the auger during movement through the compost, etc. A typical compost pile will obviously have a mounded profile, typically shallower towards the ends of the bay and deeper towards the center of the compost pile. It may not be necessary or possible to agitate compost below a certain height or level. For example, a compost presence sensor assembly 138 may indicate that the compost level at a given location is less than a selected minimum (e.g., two feet high). The sensor indication can be used to determine and direct the system to bypass agitation (or attempted agitation) of the compost at the lower levels. The compost presence sensor assembly can be part of a computerized system and can be operably connected to or in communication with one or more computers and software programs run by such computers.

Proximity sensor assemblies, as discussed herein, can be used to control movement of the carriage assembly and the gantry assembly. Proximity sensor assemblies are known in the art and available in various styles and types. The proximity sensor assemblies can be part of a computerized system and can be operably connected to or in communication with one or more computers and software programs run by such computers.

For each of the sensor assemblies, upon sensing a selected limit of the measured parameter, or upon query from the computer system, the sensor communicates a corresponding signal to the computer system 140 running the software program 144.

### Automation, Software Assembly

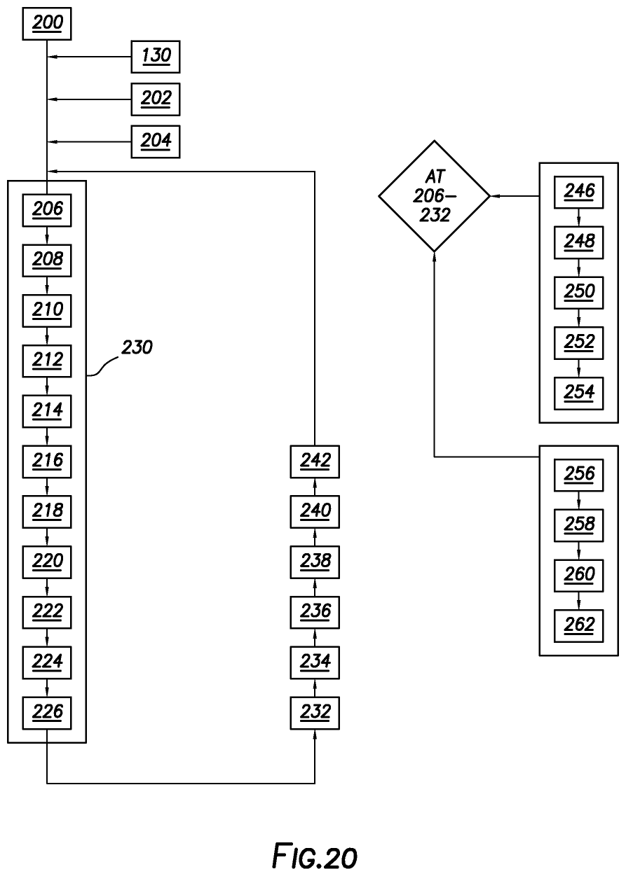

FIG. 19 is a schematic of an exemplary computerized system 140 according to aspects of the disclosure. The system 140 can be networked, that is, with the disparate parts connected or in communication, wirelessly or wired, with one another, using routers, gateways, transmitters, receivers, wires, and the like as is known in the art. Communication and control is performed by sending and receiving signals for the same, as is known in the art.

One or more of the assemblies and systems is automated using a computerized system 140. One or more computers 142 having a software program 144 stored in a non-transitory media 145 are operably connected to control the assembly equipment, to receive data from the various sensor assemblies, and to control the various assembly equipment. A software program 144 is stored on non-transitory computer readable media 145 and is executable by the computer 140 to perform or carry out certain steps, functions, actions, processes, and controls of the equipment to which they are operably connected.

The computerized system can comprise a non-transitory computer readable medium having stored thereon a software program that, when executed by a processor of a computer, causes the various assemblies and systems to activate, operate, or run. Non-transitory refers to computer-readable media that stores data for periods of time and/or in the presence of power, such as a memory device, Random Access Memory, and other memory devices as are known in the art.

For the sensor assemblies and devices (such as sensor assemblies 130, 132, 134, 136, 138 and 139a-d), the computer 142 and software program 144 are capable to receive and/or send signals to and from such devices, translate (e.g., by API), modify, and process incoming and outgoing signals, run diagnostics on such devices, and indicate errors, problems, etc. where present.

Similarly, the computer 140 and software 144 is capable of communicating with and controlling operation of the gantry assembly 20 via a gantry control system 146, the carriage assembly 50 via a carriage control system 148, the auger assembly 70 via an auger control system 150, the leachate system 80 via a leachate control system 152, and the aeration assembly 110 via an aeration control system 154, independently. The computer can receive and/or send signals to and from such devices, turn on/off motors, engage and disengage connected assemblies, engage and disengage the drive assemblies, alter motor speeds, alter speed of movement of an assembly, control movement in any selected direction (e.g., back and forth for the gantry assembly and carriage assembly, direction of rotation of the auger, etc.), and run diagnostics on such devices to indicate errors, problems, etc. where present.

Further, control, activation, and operation of the various assemblies by the computer and program are preferably automated or occurs automatically upon occurrence of preselected events. For example, the gantry, carriage and auger assemblies can be activated automatically after a selected duration of time, at a calendaring event, or upon receiving a selected sensor assembly reading. The gantry, carriage and auger assemblies can automatically run one or more stored routines from the software program to mix the compost in the bays. The moisture control system can be automatically operated upon receipt of a moisture content reading from a moisture sensor assembly or upon a signal from the leachate sensor assembly that leachate has reached a selected level in the well, for example. Similarly, the aeration system can be automatically operated upon receipt of an oxygen content reading from an oxygen sensor assembly, for example.

FIG. 20 is an exemplary flow chart for implementation by a computer software program for controlling the operable assemblies of the disclosure. The flow chart is exemplary only and it is explicitly understood that alternate and additional steps can be performed as will be apparent to those of skill in the art. Further, the steps listed can be omitted, repeated, performed in differing orders, added to, performed incrementally, etc., as will be understood by those of skill in art.

An exemplary flow chart begins at step 200. At any time, the computerized system 140 can receive and send signals to and from the various sensor assemblies 130 (including sensors 132, 134, 136, 138, and 139), as well as timers, clocks, and other input sources. Further, a calendar program 202 can communicate with the computerized system 140 to trigger or control operation of the compost management system. Further, the system and each of its component assemblies can be operated, interrupted, or programmed for automated operation by manual input 204, on-site or remotely, as indicated.

At step 206, the gantry assembly is turned “on” and/or controlled to move in a first direction along a compost bay 12. Movement continues until the compost proximity sensor assembly 138 indicates the presence of compost at the selected height at step 208, or movement continues for a selected distance (e.g., where the augering routine has already begun in a previous step). At step 210, the gantry assembly 20 is halted. At step 212 the auger assembly is activated and the auger blade turned “on” (or remains “on”).

At step 214, the carriage assembly 150 is activated and the carriage assembly 50 is controlled to move in a first direction across the bay. At step 216, a carriage proximity sensor 139 (139b, for example), senses the proximity of the carriage 50. At step 218, the carriage 50 is stopped at a selected distance from the adjacent bay wall 16 (16b, for example). At step 220, the gantry assembly 20 is activated and moved in the first direction a selected distance, then halted.

At step 222, the carriage assembly 150 is activated and the carriage assembly 50 is controlled to move in a second direction across the bay. At step 224, a carriage proximity sensor 139 (139a, for example), senses the proximity of the carriage 50. At step 226, the carriage 50 is stopped at a selected distance from the adjacent bay wall 16 (16a, for example).

The augering subroutine 230 is repeated as desired until the compost pile is fully augered in some embodiments. Gantry movement in the first direction by selected distances is repeated, and in some embodiments, alternated with carriage movement in alternating directions. This process is repeated until, as at step 232, a sensor indicates: that the compost pile is no longer proximate at the selected height, the gantry assembly 20 has reached the end of the bay 12, etc. At step 234, the auger is halted.

If not already at the end of the bay, at step 236 the gantry assembly is controlled to move in the first direction to the end of the bay 12 (12a, for example), such that the auger blade 72 is positioned in the longitudinal gap defined by the furthest extents of the exterior walls 16a and 16c and the intermediate wall 16b.

At step 238, the carriage assembly 50 is controlled to move to another bay 12 (adjacent bay 12b, for example). The auger blade 72 passes along the longitudinal gap such that it does not contact intermediate wall 16b. (Alternately, the auger assembly can be controlled to pivot the auger blade 72 out of the way, allowing the carriage assembly 50 to move transversely from one bay to another over the intermediate wall.)

At step 240, a carriage proximity sensor 139 (139a, for example) senses the proximity of the carriage assembly 50. At step 242, the carriage assembly 50 is halted. Note that during transverse movement of the carriage assembly 50 from one bay 12a to another 12b, for example, some of the carriage proximity sensors 139 (139c and 139b, for example) can be “ignored” or temporarily deactivated such that the carriage assembly 50 moves past those proximity sensors and into the selected bay 12b.

The process or parts thereof can be repeated (back to step 206 or subroutine 230, for example) with the gantry assembly 20 now controlled to move in a second direction (opposite the first direction) along the adjacent bay 12. At step 244 the method ends and the various assemblies are deactivated or turned “off” as desired.

Subroutines can be performed intermittently during operation of an augering process or separately. For example, the leachate management assembly can be operated and controlled using the computer and program. For example, at step 246 a compost moisture sensor 132 can be queried or send a signal indicating the moisture level is below a selected threshold, or alternately, the leachate well level sensor 134 can send a signal that the liquids in the well have reached a selected level. At step 248, the computer and program control the leachate assembly 152 to provide additional moisture to the compost or to drain liquids from the leachate well by turning on the pump 88, opening valves 90 as necessary, and injecting leachate onto the compost pile(s). At step 250, the gantry assembly 20 can be controlled to move along the bay(s) while the pumps are injecting liquid onto the compost piles, thereby providing liquid along the length of the compost piles or bays. The computer program can inject liquid onto the piles during augering of the compost or separately, can delay liquid injection until the next cycle of augering the compost, etc. Pumping can be turned “off” or ceased at step 254 after, at step 252, the moisture sensor indicates adequate moisture, after a selected duration of liquid injection, or when the leachate well has sunk to a selected level of liquid, for example.

Similarly, the aeration assembly can be controlled using the computer and program. For example, at step 256 an oxygen sensor 136 can be queried or send a signal indicating the oxygen level is below a selected threshold. At step 258, the computer and program control the aeration assembly 154 to provide additional air to the compost piles by turning on the fans 112, opening valves 116 as necessary, and injecting air into the compost pile(s). The fans can be turned “off” or ceased at step 262, when, at step 260, the oxygen sensor indicates adequate oxygen, after a selected duration of air injection, etc.

### Example

In an embodiment, the gantry assembly 20, powered by the gantry motor 24, and directed by the computer system and software, begins a longitudinal run along a selected bay 12a, beginning at a first end of the bay. The gantry assembly moves along the bay as the compost proximity sensor 138 senses the presence of compost at a selected height. If no compost is sensed, the gantry assembly 20 continues its movement along the bay 12a and the auger motor 74 remains off and the carriage assembly 50 remains stationary.

When the compost proximity sensor 138 senses compost at the selected proximity, a corresponding signal is sent to the computer system 140. In response, the computer software directs the auger motor 74 to turn on, the auger blade 72 to engage, and the carriage assembly 50 to move the carriage laterally across the bay 12a along carriage rail 36. The auger blade engages and mixes the compost as the carriage moves across the bay.

In an embodiment, multiple proximity sensors 139a-d are positioned on the gantry assembly 20 and arranged to detect the presence of the carriage assembly 50 when it reaches a selected proximity from the sensor. Proximity sensors 139a and 139b are positioned near the exterior wall 16a and intermediate wall 16b such that the carriage can run along the gantry carrier rail 56 between the two sensors 139a and 139b, staying within and travelling close to the walls 16a and 16b. During a pass of the gantry assembly 20 longitudinally along a first bay 12a, the sensors 139a-b are active. The carriage assembly 50 is directed to travel laterally across the gantry carriage rail 56, the auger motor running and auger blade engaged. As the carriage assembly 50 nears the first sensor 139a, the sensor sends a signal to the computer system 140. In response, the computer software sends a carriage control signal and controls the carriage assembly 50 to stop travel towards the first sensor 139a (and corresponding wall 16a), and to either stop or reverse travel along the carriage rail towards the opposing sensor 139b (corresponding to the opposing intermediate wall 16b). The process continues, sending the carriage back and forth across the bay. Between trips of the carriage across the bay, the gantry assembly moves longitudinally along the bay a selected distance. This continues, stepwise, such that the auger traces a zig-zag stepped pattern down the bay, completely mixing the compost pile.

Upon reaching the far end of the bay 12a, or upon detection by the compost proximity sensor 138 that compost is no longer present (at a selected height), the computer software directs the auger blade to disengage and/or the auger motor to turn off. Once the gantry assembly 20 reaches the end of the bay 12a, the software controls the gantry motor 24 to disengage from the drive assembly or to turn off. The gantry assembly 20 is now at the far end of the bay 12a and the auger assembly has passed the extent of the intermediate wall 16b such that it is free to move laterally into bay 12b without hitting the intermediate wall 16b.

The computer then either disengages (or “ignores” signals from) the carriage proximity sensor 139b. The computer software controls the carriage assembly 50 to move the carriage across the bay 12a and into the bay 12b. Carriage proximity sensors 139c and 139d are engaged and the carriage is directed by the software to stop proximate sensor 139c (or 139d).

The gantry assembly 20 is then directed by the software to move the opposite direction along bay 12b until the compost proximity sensor 138 detects the presence of compost in bay 12b and sends a signal indicating the same. In response, the computer software again engages or turns on the auger motor 74 and blade 72, and directs the carriage motor 60 to move the carriage 50 across bay 12b towards the opposing proximity sensor 139d (or 139c). The software controls the carriage and auger to move across the bay 12b between sensors 139c and 139d. Between sweeps across the bay 12b, the software directs the gantry assembly to move longitudinally along the bay 12b. Hence the compost in bay 12b is mixed by the auger blade in a zig-zag pattern until the compost sensor 138 no longer detects compost. Then the system is turned off at that location or after being moved to a home position (e.g., the far end of bay 12b).

The computer and software can also communicate with and control the aeration assembly 110 and leachate control assembly 80 including being able to receive and/or send signals to and from such devices, turn on/off fans 112, pumps 88, sprayers, valves 90 and 102, etc., control, where possible, direction and flow paths of fans, sprayers, pipes, valves, etc., and run diagnostics on such devices to indicate errors, problems, etc. where present.

For operation and instruction of all these systems, the computer and software can receive and/or send signals to and from servers, the cloud, via the internet, etc. and is capable of calendaring of events, delay of scheduled operations, allowing manual override of program instructions, and optimization of processes including timing, rate, duration of processes, optimization of energy efficiency, of full mixing of a bay or bays, optimization of compost parameters, etc.

The software program controls operation of the gantry assembly, including the carriage assembly, auger assembly. The program controls agitation of the compost piles in the bays by controlling movement of the gantry back and forth along the bays, movement of the auger across a bay and between bays, powering the auger, drive chain, carriages, etc.

The program, in an embodiment, controls operation of the gantry system. The program can, in any order, with some or all steps repeated or omitted, send instructions to the gantry system to perform the following processes: move forward, move backwards, stop, start, alter speed, perform diagnostics. A program can be manually or automatically created to mix a bay of compost in a selected order. One or more programs can be presented to the user for selection. A program can be manually entered by a user.

A program can be created by the computer or user to optimize operation and efficiency of the system to preferentially: complete mixing in a minimum of time, with a minimum of energy use, with a minimum of energy cost; while maintaining or achieving a selected set of parameters (e.g., moisture content, oxygen content, gas content, temperature minimum/maximum, etc.), etc. For example, to certify pathogen-free compost, temperature must be maintained at or above a selected temperature (e.g., 140 degrees F.) for a certain duration. The program can instruct operation of the system components to guarantee that the temperature is maintained by controlling mixing, aeration, moisture addition, etc.

For example, a program can instruct the gantry, carriage, and auger assemblies to: turn on/off; move the gantry forward/back; move at a selected rate; move conditional on a selected parameter or set of parameters (e.g., until a selected height of compost is encountered; until a minimum or maximum resistance is encountered, etc.); move the carriage back/forth; move at a selected rate; move conditional on a selected parameter or set of parameters (e.g., until a selected height of compost is encountered; until a minimum or maximum resistance is encountered, etc.); turn on/off the auger; operate the auger conditional on a selected parameter or set of parameters (e.g., when and/or if a selected level of compost is encountered, when a minimum or maximum torque is encountered); move the gantry and carriage individually or simultaneously; move the gantry drive assembly and the carriage assembly to achieve a selected pattern of mixing in a bay (e.g., a zig-zag or stair-stepped pattern, etc.); move the gantry and carriage to achieve positioning of the auger and/or mixing of compost piles in a selected bay or series of bays; cease, slow or speed movement of gantry, carriage and/or auger upon preselected conditions (e.g., moisture content, oxygen content, resistance to movement, temperature of compost, presence or absence of a chemical, composition, additive, or compost type, etc.); select patterns of movement on an x-y axis or grid for the auger or assembly; and perform actions at particular times or upon occurrence of particular events or parameters.

Similarly, the software program can control operation of the moisture control assembly and/or aeration assemblies. The program controls aeration of and moisture addition to the compost piles in the bays by controlling operation of the aeration and moisture control assemblies. The program can control the aeration assembly by turning on/off the fans, controlling fan speeds, operating valves, dampers, or other flow control devices, etc. Similarly, the program can instruct the moisture control assembly components turning on/off pumps, controlling pump speeds and pressures, controlling fluid control valves or other flow control devices, etc.

The software program can, in any order, with some or all steps repeated or omitted, send instructions to the aeration and moisture control systems to perform the following processes: turn on/off, increase air or liquid flow, stop, start, alter speed, and perform diagnostics. A program can be manually or automatically created to aerate and control moisture in a selected order or at a selected time or upon a selected set of conditions. One or more programs can be presented to the user for selection. A program can be manually entered by a user.

The software program can optimize operation and efficiency of the systems to preferentially: complete aeration or moisture control in a minimum of time, with a minimum of energy use, with a minimum of energy cost, with a minimum use of fresh water, etc.; while maintaining or achieving a selected set of parameters (e.g., moisture content, oxygen content, gas content, temperature minimum/maximum, etc.), etc.

Generally, the computerized system can receive or solicit data from the sensors, and where necessary, translate, manipulate or otherwise alter those signals, interpret those signals, compare them to selected maximums, minimums, etc., and then instruct operation of system components and assemblies in response thereto. For example, the program can shut off operation of the mixing assembly until a certain moisture content level is met or signal received; turn on and control liquid flow rates and sources until a moisture content is measured; turn on and control air flow levels until a certain oxygen content is achieved or until a certain threshold of gas level is achieved; etc. The program can be updated, altered, operated and re-programmed, preferably on-line via the internet or cloud. In some embodiments, the system can also be controlled remotely via the internet, cloud-based servers, etc. Controls and signals can be wired or wireless.

### Cable and Hose Management

The system uses multiple cables and hoses, including power cables, control cables, air and liquid hoses, etc. A control system for managing these cables and hoses without kinking or tying is commercially available. For example, an IGUS Track system is commercially available from IGUS, Inc.

### Definitions

Computer and Computerized System: The system, methods, and other embodiments according to the present disclosure include computerized systems requiring the performance of one or more methods or steps performed on or in association with one or more computer. A computer is a programmable machine having two principal characteristics: it responds to a set of instructions in a well-defined manner and can execute a pre-recorded list of instructions (e.g., a program). A computer according to the present disclosure is a device with a processor and a memory. For purposes of this disclosure, a computer includes a server, a personal computer, (i.e., desktop computer, laptop computer, netbook), a mobile communications device, such as a mobile “smart” phone, and devices providing functionality through internal components or connection to an external computer, server, or global communications network (such as the internet) to take direction from or engage in processes which are then delivered to other system components.

Other devices, alone or in conjunction with an architecture associated with a system, can provide a computerized environment for carrying out the methods disclosed herein. The method aspects of the disclosure are computer implemented and, more particularly, at least one step is carried out using a computer.

General-purpose computers include hardware components. A memory or memory device enables a computer to store data and programs. Common storage devices include disk drives, tape drives, thumb drives, and others known in the art. An input device can be a keyboard, mouse, hand-held controller, remote controller, a touchscreen, and other input devices known in the art. The input device is the conduit through which data and instructions enter a computer. An output device is a display screen, printer, or other device letting the user sense what the computer has accomplished, is accomplishing, or is expected to accomplish. A central processing unit (CPU) is the “brains” of the computer and executes instructions and performs calculations. For example, typical components of a CPU are an arithmetic logic unit (ALU), which performs arithmetic and logical operations and a control unit (CU) which extracts instructions from memory, decodes and executes them, calling on the ALU when necessary. The CPU can be a micro-processor, processor, one or more printed circuit boards (PCBs). In addition to these components, others make it possible for computer components to work together or in conjunction with external devices and systems, for example, a bus to transmit data within the computer, ports for connectivity to external devices or data transmission systems (such as the internet), wireless transmitters, read and read-write devices, etc., such as are known in the art.

Network: A computer network, computerized network, or data network is a communications network allowing computers to exchange data, with networked devices passing data to each other on data connections. Network devices that originate, route, and terminate data are called nodes. The connections (links) between nodes are established using wire or wireless media. Nodes can include hosts, such as PCs, phones, servers, and networking hardware. Devices are networked together when one device is able to exchange information with the other device whether or not they have a direct connection to each other. Computer networks support applications such as access to the World Wide Web (WWW) or internet, shared use of application and storage servers, printers, and use of email and instant messaging applications. Computer networks differ in the physical media to transmit signals, protocols to organize network traffic, network size, topology, and organizational intent.

Firmware: In electronic systems and computing, firmware refers to the combination of one or more hardware devices (e.g. an integrated circuit) and computer instructions, programming or coding, and data that reside as read-only software on those devices. Firmware usually cannot be modified during normal operation of the device. Typical examples of devices containing firmware are embedded systems (e.g., gantry control systems on the gantry assembly, auger control systems on the auger assembly, carriage control systems on the carriage assembly). The firmware contained in these devices provides the control program for the device.

Router: A router forwards data packets along networks and is connected to at least two networks, commonly two LANs, WANs, or a LAN and its ISP's network. Routers are located at “gateways,” the places where two or more networks connect. Routers use headers and forwarding tables to determine paths for forwarding packets and use protocols to communicate with each other to configure a route between hosts.

Database: The disclosure includes one or more databases for storing information relating to aspects of the disclosure. The information stored on a database can, for example, be related to a private subscriber, a content provider, a host, a security provider, etc. One of ordinary skill in the art appreciates that “a database” can be a plurality of databases, each of which can be linked to one another, accessible by a user via a user interface, stored on a computer readable medium or a memory of a computer (e.g., PC, server, etc.), and accessed by users via global communications networks (e.g., the internet) which may be linked using satellites, wired technologies, or wireless technologies.

### Methods

The steps described below can occur as stated, in any order, with some steps omitted, with additional steps intervening at any point, with steps repeated, etc. For clarity, where a method is described as having steps ABC, the disclosed methods also include steps ACB, BAC, BCA, CAB, and CBA. Further, where an additional step or steps D is disclosed, the methods disclosed herein also include methods comprising steps ABCD, ABDC, BACD, BADC, and the like, as well as methods comprising ABD, ACD, BCD, and the like. It is explicitly understood that this disclosure teaches that the method steps can be performed in any order, with or without all steps being performed and with additional steps added, that a person of ordinary skill in the art would understand. Hence, the numbering and sequence of the steps described hereinafter are not in any way limiting to the methods disclosed herein. 16. A method of automatically managing compost in compost bays, the method comprising: sensing a parameter related to compost positioned in a compost bay; automatically mixing compost positioned in a compost bay in response to the sensing of a parameter related to the compost of the compost by: powering a gantry assembly to move longitudinally along a bay, the gantry assembly bridging at least one compost bay; driving a carriage mounted for reciprocating lateral movement across the compost bay, the carriage supported by the gantry assembly, the carriage supporting a powered mixing blade; and powering the mixing blade and mixing the compost as the carriage is driven across the compost bay. 17. The method of claim 16, further comprising repeatedly and alternatingly (a) powering the gantry assembly to move longitudinally in a first direction along the compost bay, and (b) driving the carriage to move laterally across the compost bay while powering the mixing blade. 18. The method of claim 16, wherein sensing a parameter related to compost positioned in a compost bay further comprises: sensing a moisture level in the compost, sensing the oxygenation of the compost, or sensing a liquid level in a leachate well fluidly connected to the gantry assembly. 19. The method of claim 16, further comprising, sensing the presence of a predetermined level of compost in the compost bay, and automatically powering the mixing blade in response to thereto; and thereafter, sensing the absence of compost at a predetermined level in the compost bay and, in response thereto, automatically ceasing powering of the mixing blade. 20. The method of claim 16, further comprising: automatically dispersing liquid onto compost positioned in the compost bay in response to sensing a predetermined moisture level in the compost or a predetermined level of fluid in an associated fluid well. 21. The method of claim 20, further comprising automatically pumping leachate fluid onto the compost from a leachate well in fluid communication with a dispersal mechanism mounted on the gantry assembly. 22. The method of claim 16, further comprising: automatically aerating compost positioned in the compost bay in response to sensing a predetermined oxygen level in the compost. 23. The method of 22, further comprising: automatically blowing air into the compost via air conduits positioned in a floor of the compost bay. 24. The method of 23, wherein the air conduits comprise a plurality of air holes positioned to provide air into the compost bay, and wherein blowing air further includes forcing air through the air holes by creating sufficient static pressure to force air into compost in the compost, regardless of whether some of the air holes are covered by compost. 25. The method of claim 20, further comprising draining leachate from the compost bay into a leachate well through channels defined in a floor of the compost bay. 26. The method of claim 16, further comprising driving the carriage from a first compost bay to a second, generally parallel compost bay, and either passing the mixing blade over a wall separating the first and second bays or passing the mixing blade across an end of a wall separating the first and second bays. 27. The method of claim 16, further comprising, by a software program stored on a non-transitory computer readable medium and executable by a processor of a computer, receiving signals from sensor assemblies, the sensor assemblies sensing parameters related to the compost positioned in the compost bay, and causing the automatic powering of the gantry assembly, driving of the carriage, and powering of the mixing blade.

### CONCLUSION

The words or terms used herein have their plain, ordinary meaning in the field of this disclosure, except to the extent explicitly and clearly defined in this disclosure or unless the specific context otherwise requires a different meaning. The words “comprising,” “containing,” “including,” “having,” and all grammatical variations thereof are intended to have an open, non-limiting meaning. For example, an apparatus comprising a part does not exclude it from having additional parts, and a method having a step does not exclude it having additional steps. When such terms are used, the apparatuses and methods that “consist essentially of” or “consist of” the specified components, parts, and steps are specifically included and disclosed.

The indefinite articles “a” or “an” mean one or more than one of the component, part, or step that the article introduces. The terms “and,” “or,” and “and/or” shall be read in the least restrictive sense possible. Each numerical value should be read once as modified by the term “about” (unless already expressly so modified), and then read again as not so modified, unless otherwise indicated in context. When a numerical range or measurement with a lower limit and an upper limit is disclosed, any number and any range falling within the range is also intended to be specifically disclosed.

While the foregoing written description of the disclosure enables one of ordinary skill to make and use the embodiments discussed, those of ordinary skill will understand and appreciate the existence of variations, combinations, and equivalents of the specific embodiments, methods, and examples herein. The disclosure should therefore not be limited by the above described embodiments, methods, and examples. While this disclosure has been described with reference to illustrative embodiments, this description is not intended to be construed in a limiting sense. Various modifications and combinations of the illustrative embodiments as well as other embodiments of the disclosure will be apparent to persons skilled in the art upon reference to the description. It is, therefore, intended that the appended claims encompass any such modifications or embodiments.

The particular embodiments disclosed above are illustrative only, as the present disclosure may be modified and practiced in different but equivalent manners apparent to those skilled in the art having the benefit of the teachings herein. It is, therefore, evident that the particular illustrative embodiments disclosed above may be altered or modified and all such variations are considered within the scope of the present disclosure. The various elements or steps according to the disclosed elements or steps can be combined advantageously or practiced together in various combinations or sub-combinations of elements or sequences of steps to increase the efficiency and benefits that can be obtained from the disclosure. It will be appreciated that one or more of the above embodiments may be combined with one or more of the other embodiments, unless explicitly stated otherwise. Furthermore, no limitations are intended to the details of construction, composition, design, or steps herein shown, other than as described in the claims.

1. An automated compost management system comprising:
first and second parallel compost bays;
a powered gantry assembly bridging the first and second compost bays, the powered gantry assembly selectively movable longitudinally along the compost bays;
a driven carriage mounted for reciprocating lateral movement across the first compost bay, the carriage supported by the gantry assembly, the carriage movable to the second compost bay for reciprocating lateral movement across the second compost bay; and
a powered mixing assembly carried by the carriage and having a mixing blade for mixing compost positioned in the compost bays as the gantry assembly and carriage move across the compost bays.

2. The system of claim 1 further comprising a non-transitory computer readable medium having stored thereon a software program that, when executed by a processor of a computer, cause the gantry assembly to move longitudinally along the compost bays, the carriage to move laterally across the first compost bay, and the mixing blade to mix compost positioned in the first compost bay.

3. The system of claim 2 wherein the software program further repeatedly causes alternating steps of causing: the gantry assembly to move longitudinally a selected distance in a first direction; and the carriage to move laterally across the first compost bay.

4. The system of claim 3, further comprising a compost sensor assembly for determining the presence of a predetermined level of compost in the compost bays, the compost sensor assembly in communication with the software program, the software program causing the mixing assembly to automatically begin driving the mixing blade when the presence of compost is sensed by the compost sensor assembly.

5-6. (canceled)

7. The system of claim 2, further comprising a moisture control assembly having a liquid dispersal mechanism mounted to the gantry and in fluid communication with a liquids source, and a pump for pumping fluids from the fluids source to the dispersal mechanism; and
wherein the software program automatically causes the pump to pump fluids from the fluids source to and out of the dispersal mechanism and onto compost in the compost bays.

8. The system of claim 7, further comprising a moisture sensor assembly for detecting moisture content in compost in the compost bays, the moisture sensor assembly in communication with the software program, the software program automatically causing the moisture control assembly to pump liquids onto compost in the compost bays in response to communication from the moisture sensor assembly.

9. (canceled)

10. The system of claim 1, further comprising an aeration assembly having air conduits positioned under the floor of the compost bays in fluid communication with a fan for blowing air through the air conduits and into compost in the compost bays.

11. The system of claim 2, further comprising an aeration assembly having air conduits positioned under the floor of the compost bays in fluid communication with a fan for blowing air through the air conduits and into compost in the compost bays; and
wherein the software program automatically causes the fan to blow air through the air conduits and into compost in the compost bays.

12. The system of claim 11, further comprising an oxygen sensor assembly for sensing oxygen levels in compost in the compost bays, the oxygen sensor assembly in communication with the software program, the software program automatically causing the aeration assembly to blow air into compost in the compost bays in response to communication from the oxygen sensor assembly.

13. The system of claim 10, wherein the air conduits further comprise a plurality of air holes positioned to provide air into the compost bays, and wherein the fan forces air through the holes by creating sufficient static pressure to force air into compost in the compost, regardless of whether some of the holes are covered by compost.

14. (canceled)

15. The system of claim 7, further comprising a leachate management assembly having fluid channels defined in the floor of the compost bays in fluid communication with a leachate well, the fluid channels for draining leachate from compost in the compost bays into a leachate well; and
wherein the software program automatically causes the pump to pump fluids from the fluids source to and out of the dispersal mechanism and onto compost in the compost bays, and wherein the fluids source is at least in part the leachate well.

16. A method of automatically managing compost in compost bays, the method comprising:
sensing a parameter related to compost positioned in a compost bay;
automatically mixing compost positioned in a compost bay in response to the sensing of a parameter related to the compost of the compost by:
powering a gantry assembly to move longitudinally along a bay, the gantry assembly bridging at least one compost bay;
driving a carriage mounted for reciprocating lateral movement across the compost bay, the carriage supported by the gantry assembly, the carriage supporting a powered mixing blade; and
powering the mixing blade and mixing the compost as the carriage is driven across the compost bay.

17. The method of claim 16, further comprising repeatedly and alternatingly (a) powering the gantry assembly to move longitudinally in a first direction along the compost bay, and (b) driving the carriage to move laterally across the compost bay while powering the mixing blade.

18. The method of claim 16, wherein sensing a parameter related to compost positioned in a compost bay further comprises: sensing a moisture level in the compost, sensing the oxygenation of the compost, or sensing a liquid level in a leachate well fluidly connected to the gantry assembly.

19. The method of claim 16, further comprising, sensing the presence of a predetermined level of compost in the compost bay, and automatically powering the mixing blade in response to thereto; and thereafter, sensing the absence of compost at a predetermined level in the compost bay and, in response thereto, automatically ceasing powering of the mixing blade.

20. The method of claim 16, further comprising: automatically dispersing liquid onto compost positioned in the compost bay in response to sensing a predetermined moisture level in the compost or a predetermined level of fluid in an associated fluid well.

21. The method of claim 20, further comprising automatically pumping leachate fluid onto the compost from a leachate well in fluid communication with a dispersal mechanism mounted on the gantry assembly.

22. (canceled)

23. The method of 22, further comprising: automatically blowing air into the compost via air conduits positioned in a floor of the compost bay.

24-25. (canceled)

26. The method of claim 16, further comprising driving the carriage from a first compost bay to a second, generally parallel compost bay, and either passing the mixing blade over a wall separating the first and second bays or passing the mixing blade across an end of a wall separating the first and second bays.

27. The method of claim 16, further comprising, by a software program stored on a non-transitory computer readable medium and executable by a processor of a computer, receiving signals from sensor assemblies, the sensor assemblies sensing parameters related to the compost positioned in the compost bay, and causing the automatic powering of the gantry assembly, driving of the carriage, and powering of the mixing blade.
